(19) United States
(12) Patent Application Publication
(10) Pub. No.: US 2006/0011492 A1
(43) Pub. Date: Jan. 19, 2006

(54) Method for machining workpieces using a machining process in particular an electrochemical machining process

(76) Inventor: Gerhard Moeckl, Lenningen (DE)

Correspondence Address: KENYON & KENYON, ONE BROADWAY, NEW YORK, NY, 10004, US

(21) Appl. No.: 10/510,137

(22) PCT Filed: Mar. 25, 2003
(86) PCT No.: PCT/DE03/00977

§ 371 Date: Aug. 11, 2005

(30) Foreign Application Priority Data
Apr. 3, 2002 (DE) 10214618.7

(51) Int. Cl. B23H 7/18; C25F 7/00

(52) U.S. Cl. 205/643; 205/668

(57) ABSTRACT

A method is provided for the processing of workpieces using a processing method, in particular the electrochemical processing method. In the process, a is applied between an electrode and a workpiece, so that, for the removal or deposit of material, a current flows between the electrode and the workpiece through a working medium, in particular an electrolyte solution. The voltage for processing of the at least one workpiece is increased and the current monitored. The voltage is increased to a specified value via a ramp. In this way, it is possible to specify substantially narrower limits for the current characteristic during processing. This also results in narrower limits for dimensional accuracy and higher quality of the workpieces. The load on the electrode is reduced as well.

### FIELD OF THE INVENTION

The present invention is based on a method for processing using a processing method, in particular the electrochemical processing method.

### BACKGROUND INFORMATION

In a method for processing workpieces using a processing method, which may be the electrochemical processing method, a voltage is applied between an electrode and a workpiece. The applied voltage generates a current flow between the electrode and the workpiece through a working medium, which is an electrolyte solution in electrochemical material processing, in this way removing or depositing material.

To prevent short-circuits between the workpiece and the electrode, a low test voltage is applied first and the current flow measured in the process. If a specified value is not exceeded, the processing may begin. For this purpose, the voltage is increased abruptly, resulting in a high initial current since the gap or the distance between the workpiece and the electrode is still very small. During processing, the electrode is not moved relative to the workpiece. This causes the gap or the distance to increase during processing due to the removal of material. As a result, the resistance in the gap rises as well, and the current is considerably reduced in the course of processing. The current thus changes over a relatively large range during processing. However, this may also cause greater variations in dimensional accuracy as well as the quality of the section to be processed. Furthermore, there is also more stress on the electrode and increased wear.

A method for processing workpieces using the electrochemical processing method is known from German Patent No. 40 40 590 where a voltage is applied between at least one electrode and at least one workpiece, so that, for the removal of material, a current flows between the at least one electrode and the at least one workpiece through the in particular electrolyte solution. In this case, the current is regulated, which means that the voltage is set according to the setpoint selection for the selected current value. Especially when a plurality of workpieces is to be processed in parallel, it may happen, for instance, that the resistance in one workpiece is considerably lower than it is in another. Therefore, a correspondingly high current will flow through this workpiece, and there is the risk of too much material being removed. On the other hand, the remaining workpieces will then lack sufficient processing. The electrochemical processing with the aid of current regulation should therefore be limited to the processing of one work piece.

In addition, there is electrochemical processing during which the electrode is moved, so that the gap between the electrode and the work piece remains unchanged. In this way, the resistance between the electrode and the workpiece will remain approximately constant, and the current therefore as well.

### SUMMARY OF THE INVENTION

In contrast, the method of the present invention for processing utilizing a processing method, in particular the electrochemical processing method has the advantage that considerably narrower limits may be specified for the current movement during monitoring of the current. This also increases the dimensional accuracy of the workpieces. Furthermore, the maximum current flowing through the electrode is lower as well, which means less heating of the electrode, resulting in a longer service life. This is accomplished by increasing the voltage via a ramp to a predefined value following the test cycle. The current follows this increase and changes within considerably narrower limits.

It is advantageous if the voltage characteristic is specified during processing and the current is measured and compared to a predefined range, this range being formed by a lower limit value and an upper limit value. Processing should be stopped if the measured current is outside the at least one predefined range, thereby preventing damage as a result of excessive currents or faulty parts caused by insufficient processing.

In a further development, the voltage may be increased to a higher value or reduced to a lower value via a ramp once the first value has been attained. By appropriate selection of the ramps, a relatively constant current characteristic may be achieved.

Workpieces that are acceptable after processing are distinguished by a specific resistance range, which is a function of the size of the gap between the electrode and workpiece and the working medium in-between. This also results in a specific mandatory range for the current. This circumstance may be utilized for quality control in that the current measured at the end of processing is compared to a second specified range, which is smaller than the range specified during processing. If the current is within this range, the workpiece is in order.

What applies to the end of processing may also be utilized for the beginning of processing. Prior to processing, the resistance in the gap between the electrode and workpiece must be within a certain range as well, so that the required current will flow during a predefined time for processing at a specified voltage characteristic. If the resistance is too high, insufficient processing will result in the end, in particular in the case of processing on the basis of a predefined time period. If the resistance is too low, too much material will be removed or deposited. Therefore, if the current is measured during the test procedure and if it is compared to a predefined range, it will be known whether the processing will most likely yield acceptable parts or whether processing must be stopped when this range is exceeded or not attained.

It is particularly advantageous to process a plurality of workpieces in parallel and to measure the current through each workpiece.

Furthermore, in an especially advantageous manner this method may be used for processing with an electrode that does not move relative to the workpiece during processing.

Additional advantages and advantageous further developments of the processing method utilizing a processing method according to the present invention, in particular the electrochemical processing method, result from the dependent claims and the specification.

### BRIEF DESCRIPTION OF THE DRAWINGS

FIG. 1 shows the graphic characteristic of voltage and current over time during an electrochemical material processing.

FIG. 2 shows the graphic characteristic of voltage and current over time during a second electrochemical material processing.

### DETAILED DESCRIPTION

The principle of electrochemical material processing is based on the application of a direct voltage to two electrodes, which are situated in a watery electrolyte solution used as working fluid. In this context, the workpiece to be processed is connected to the positive pole (anode) of a current source, using a transmission element, whereas an electrode acting as tool is connected to the negative pole (cathode) of the current source due to its electrically conductive properties.

The composition of the electrolyte solution depends on the material of the component to be processed. With metals, for example, a sodium chloride solution or a sodium nitrate solution is selected. The electrochemical process as such is known from physics and will therefore not be discussed here in greater detail. The method of operation not only depends on the composition of the electrolyte solution but also on the selected current intensity, which in turn must be adapted to the material of the workpiece to be processed.

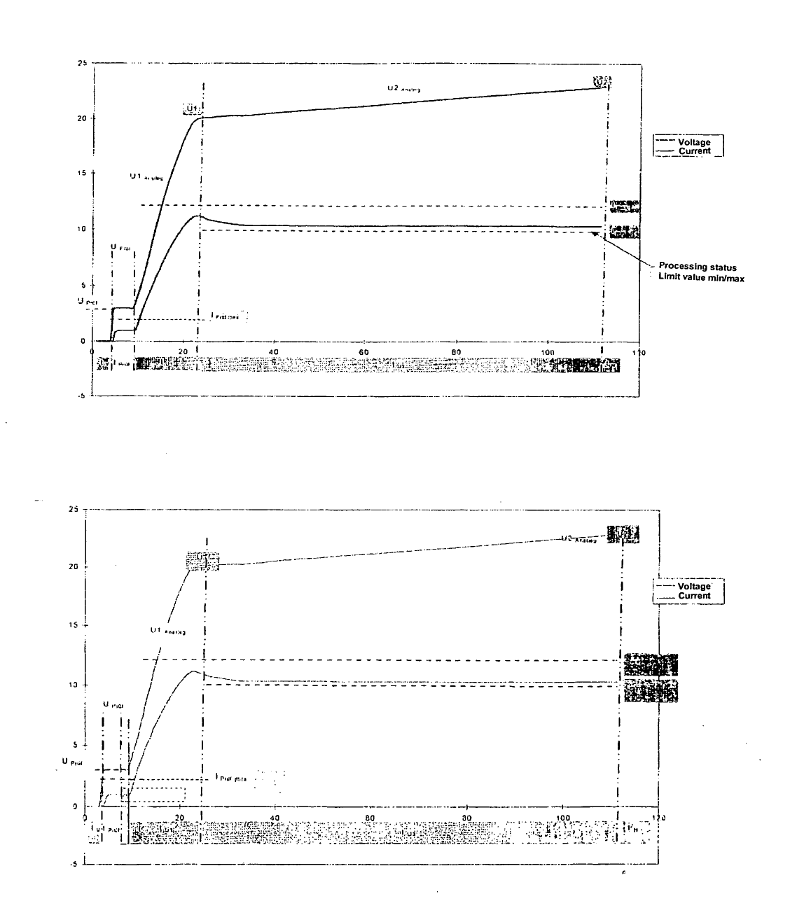

FIG. 1 shows the voltage and current characteristic during electrochemical processing of a workpiece over time. The upper line represents the voltage and the lower line the current.

The present invention relates to processing in which the one electrode or the plurality of electrodes is stationary relative to the workpiece or the workpieces during processing, such a scenario being conceivable as well.

The following applies concerning the abbreviations used in FIG. 1:

Uₜₑₛₜ: This is a test voltage applied at the beginning of the process. Test voltage Uₜₑₛₜ allows an early detection of a short circuit between the workpiece and the electrode. Test voltage Uₜₑₛₜ is applied prior to each processing procedure; the range is between 2V and 5V, for example. The application of the test voltage at the workpieces must be ascertained for a valid test.

Iₜₑₛₜₘₐₓ: This is a maximum current that is allowed to flow when test voltage Uₜₑₛₜ is applied. Should the actual current Iₜₑₛₜₘₐₓ exceed this setpoint value, the test will be considered unsuccessful. The range of current Iₜₑₛₜₘₐₓ is between 2A and 5A, for example.

tₜₑₛₜ: This is the time during which test voltage Uₜₑₛₜ is applied.

U1: This is a voltage value that will be targeted next via a ramp, after successful testing, taking time tU1 into account; in other words, a successive voltage increase takes place. In the case at hand, a ramp may have a continuous profile or be made up of small voltage steps.

t_{U1}: This is the time for the process from the end of the test to attainment of voltage value U1.

U2: This is the final voltage value of the process. If there is a difference between U1 and U2, a successive voltage modification will take place here as a function of time t_{U2}, also along a ramp.

t_{U2}: This is the time for the process from reaching U1 until reaching final voltage value U2.

Iₘᵢₙ: This is a lower current limit value during actual processing, i.e., during time t_{U2}. If the current falls below this current value Iₘᵢₙ during processing when the voltage increases from U1 to U2, the processing of the workpiece is stopped. After a specified number of such errors, processing will be abandoned.

Iₘₐₓ: This is the upper current limit value for time t_{U2}. If the current exceeds this value during the process or during the transition from Uₜₑₛₜ to U1 to U2, the voltage source is switched off immediately.

Processing status limit value max/min: This is a window or range towards the end, for example a few second before the end, or at the end of processing. Here it is checked whether the current is within the window stipulated by the processing status limit value max/min. It is possible to infer the workpiece geometry in this manner. The limit values play a decisive role in dimensional accuracy and the quality of the workpieces.

In the method for processing workpieces using the electrochemical processing method, a voltage is applied between at least one electrode and at least one workpiece. In the present method, a plurality of workpieces may easily be processed in parallel. For removal of material, current flows between the electrode and the workpiece through the electrolyte solution. It is important that the voltage for processing the workpiece be the control or reference variable. The current follows this specified variable and is monitored in the process. This means that it is a voltage-controlled process. In the case of a plurality of workpieces to be processed in parallel, satisfactory processing of all workpieces is ensured if the current is monitored at each workpiece.

The voltage, which is set possibly even skipping the test procedure, must not be raised abruptly. Instead, it is to be increased via a ramp to the predefined value U1 at which significant processing will then occur. This prevents current spikes and thus protects the electrode. Furthermore, the current stays within narrow limits during actual processing time t_{U2}.

After value U1 has been attained, the voltage is increased to the higher value U2 via a ramp. The ramp or the voltage increase is specified such that the current will remain as constant as possible. However, it is also possible that the voltage remains constant or will be decreased to a lower value via a ramp once value U1 has been attained. This is useful, for instance, for processes during which material is deposited and the clearance between a workpiece and an electrode decreases. Also important in this context are the limit values Iₘᵢₙ and Iₘₐₓ to which the current is compared. To avoid damage to the workpieces, the processing will be stopped as soon as the measured current is outside the range specified by limit values Iₘᵢₙ and Iₘₐₛ. If the current exceeds or falls short of the predefined range at the end of the test procedure, the processing should be stopped as well.

It is also possible for further similar processing steps to be added on once voltage U2 has been attained.

Iₘᵢₙ and Iₘₐₓ may be fixed values for the entire procedure beginning with t_{U1} to the end of the process or they may also be defined as variable for each processing step, that is to say, they may change over time.

FIG. 2 shows processing entailing an additional test. An additional window can be gathered near the end of the test procedure. This window is formed by an upper current value and a lower current value. The upper current is lower than the maximally allowed current value Iₜₑₛₜₘₐₓ. If the current is in this window toward the end of the test procedure at voltage Uₜₑₛₜ, this means that the overall resistance, which . . . via the lines, the workpiece, the electrode etc. as well as especially the working gap formed with the electrolyte solution between the workpiece and the electrode, has a correct value or is within a predefined range. On the basis of this value or range, which may be ascertained by reference measurements or be calculated with the aid of a computer, it may be inferred that, given a specified voltage profile, a certain current characteristic and thus a certain processing degree must come about in the end. As a result, it is even conceivable to dispense with the comparison of the current to the range “processing status limit value max/min” at the end of processing.

The described method is not limited to only electrochemical material processing using an electrolyte solution as working medium. The method may also be used for galvanic, electro-erosive or spark-eroding processing of a workpiece, the coating of a workpiece or the like in which another working medium is possibly utilized. Also, it is not only the case that material must be removed; methods in which material is deposited are possible as well.

1-13. (canceled)

14. A method for processing at least one workpiece according to an electrochemical processing, comprising:
applying a voltage between at least one electrode and the at least one workpiece, so that, for one of a removal and a deposit of a material, a current flows between the at least one electrode and the at least one workpiece, through the medium;
increasing the voltage for the processing of the at least one workpiece, the voltage being increased via a ramp to a predefined value; and
monitoring the current.

15. The method as recited in claim 14, wherein:
the medium includes an electrolyte solution.

16. The method as recited in claim 14, wherein the increasing includes:
after the voltage attains the predefined value, increasing the voltage to a higher value via the ramp.

17. The method as recited in claim 14, further comprising:
after the voltage attains the predefined value, lowering the voltage to a lower value via the ramp.

18. The method as recited in claim 14, wherein:
after attaining the predefined value, the voltage is one of increased to a higher value via the ramp and lowered to a lower value via the ramp in such a way that an essentially constant current characteristic is obtained.

19. The method as recited in claim 14, further comprising:
specifying a voltage characteristic during processing;
measuring the current; and
comparing the current to at least one predefined range formed by a lower limit value and an upper limit value.

20. The method as recited in claim 19, further comprising:
stopping the processing if the measured current is outside the at least one predefined range.

21. The method as recited in claim 14, further comprising:
comparing a current measured one of toward and at an end of processing to a second predefined range that is smaller than a range specified during processing.

22. The method as recited in claim 14, further comprising:
comparing the current to a specified range at an end of a test procedure; and
stopping the processing when the specified range is one of exceeded and not attained.

23. The method as recited in claim 14, wherein:
the at least one workpiece includes a plurality of workpieces, and
the plurality of workpieces is processed in parallel and the current through each workpiece is measured.

24. The method as recited in claim 14, wherein:
the at least one electrode is not moved relative to the at least one workpiece during processing.

25. The method as recited in claim 14, further comprising:
comparing the current to a specified range during a test procedure.

26. The method as recited in claim 25, further comprising:
abandoning the processing when the specified range is one of exceeded and not attained.

27. The method as recited in claim 14, further comprising:
prior to increasing the voltage, implementing a test procedure using a test voltage.
